(19) United States
(12) Patent Application Publication
(10) Pub. No.: US 2013/0039834 A1
(43) Pub. Date: Feb. 14, 2013

(54) METHOD FOR PRODUCING AMMONIA

(71) Applicant: Norbert Auner, Glashuetten (DE)

(72) Inventor: Norbert Auner, Glashuetten (DE)

(73) Assignee: Spawnt Private S.à.r.l., Luxembourg (LU)

(21) Appl. No.: 13/581,023

(22) PCT Filed: Feb. 28, 2011
(86) PCT No.: PCT/EP2011/052928

§ 371 Date: Oct. 15, 2012

(30) Foreign Application Priority Data
Feb. 26, 2010 (DE) 102010009500.1

(51) Int. Cl. C01C 1/04

(52) U.S. Cl. 423/359

(57) ABSTRACT

A method produces ammonia by reacting N₂ with H₂ to produce a low-temperature plasma discharge. The gas mixture in which the low temperature plasma discharge is produced can also contain a diluted inert gas and/or admixtures favoring the plasma discharge. Also, the reaction can take place in the presence of a catalyst.

### RELATED APPLICATIONS

This is a §371 of International Application No. PCT/EP2011/052928, with an international filing date of Feb. 28, 2011, which is based on German Patent Application No. 10 2010 009 500.1, filed Feb. 26, 2010, the subject matter of which is incorporated by reference.

### TECHNICAL FIELD

This disclosure relates to a method for producing ammonia.

### BACKGROUND

There are many methods for producing ammonia, the best known of which is the Haber-Bosch process. The so-called “Serpek” process, which relates to the hydrolysis of nitrides, is also known. The hydrolysis of silicon nitride is described in previously unpublished DE 10 2009 011 311.8.

It could nonetheless be helpful to provide another particularly simple and economical way of producing ammonia.

### SUMMARY

I provide a method for producing ammonia by reacting N₂ with H₂ with formation of a low-temperature plasma discharge.

### DETAILED DESCRIPTION

A plasma process is used for producing ammonia. A zone in which the reaction to ammonia takes place is characterized by comparatively low gas temperatures as well as by comparatively low wall temperatures of the reactor.

“Plasma” as used herein means a gas or a gas mixture characterized by a variable proportion of non-neutral gas particles higher than that arising from natural environmental conditions.

“Plasma discharge” means generation of a plasma by action of suitable forms of energy on a gas or a gas mixture. Depending on the conditions of plasma generation, the plasma discharge is not necessarily accompanied by optical effects such as a visible glow.

The ammonia produced by the method is in the form of a colorless gas which can be led out of the plasma reactor used for carrying out the method and can be supplied for appropriate further use.

The method for producing ammonia can basically be implemented by two different variations of the plasma reaction:

In a first variation, the low-temperature plasma discharge is produced in a gas mixture consisting of N₂ and H₂ or containing N₂ and H₂.

In a second variation, the low-temperature plasma discharge is produced in a gas which is subsequently mixed with a gas consisting of N₂ and/or H₂ or containing N₂ and/or H₂.

The gas in which the low-temperature plasma discharge is produced can additionally contain a diluting inert gas, in particular argon or helium, and/or admixtures promoting plasma discharge. In both variations, plasma generation can additionally be supported by suitable measures. Nonlimiting examples of these supporting measures are for instance injection of electrodes from a hot cathode or an electron gun or production of free charge carriers by applying a high voltage or use of ionizing radiation.

Preferably, the low-temperature plasma discharge is generated by action of an alternating electromagnetic field, especially of microwave energy.

In one configuration, a plasma may be produced in a mixture of nitrogen (N₂) and hydrogen (H₂) under reduced pressure by action of an alternating electromagnetic field, for example, by irradiation with microwaves. Irradiation can be carried out continuously or discontinuously.

In another configuration, to stabilize the plasma, additionally a high voltage (d.c. voltage or a.c. voltage) is applied between two electrodes located outside of the discharge zone, by which the discharge current produces free charge carriers in the discharge zone. This greatly facilitates injection of the alternating electromagnetic field into the gas mixture so that the plasma is generated at far lower irradiation energy than without an applied high voltage. Furthermore, when supported with high voltage, it is possible to use higher pressures within the reaction zone so that the amount of ammonia produced per volume and time is increased.

In another configuration, a plasma is produced in a hydrogen gas stream under reduced pressure by an alternating electromagnetic field, for example, microwave radiation, wherein generation of the plasma is supported by applying a high voltage between two electrodes located outside of the plasma zone. Following the plasma zone, nitrogen is introduced into the hydrogen stream, and converted to ammonia (remote-plasma).

Preferably, the low-temperature plasma discharge is therefore supported by introducing free charge carriers into the discharge zone, wherein the free charge carriers are produced in particular by applying a high voltage between electrodes.

A low-temperature plasma discharge takes place. “Low-temperature” denotes herein that operations take place at a temperature ranging from room temperature to 800° C. Preferably, the operations take place at a temperature below 400° C., preferably below 300° C.

“Temperature” means herein the reactor temperature, and in particular the wall temperature of the reactor in which production of ammonia takes place.

During the reaction, to control the temperature, the reactor walls can be cooled by suitable measures. Examples of suitable measures are passing an air stream over them or using liquid coolants suitable for the type of apparatus.

Ammonia production takes place at a pressure from 10 to 10000 Pa (0.1 to 100 mbar), in particular at a pressure from 100 to 3000 Pa (1 to 30 mbar), preferably at a pressure from 500 to 2000 Pa (5-20 mbar). It has been found that the highest yield of ammonia can be achieved in this pressure range.

It has also been found that carrying out a catalytic reaction in the presence of a catalyst offers advantages with respect to the yield and/or course of the reaction. The reaction of N₂ with H₂ may therefore take place in the presence of a catalyst. Preferred catalysts are alkaline-earth metal oxides, MgO or platinum.

Aspects of my methods will be explained in greater detail on the basis of the following practical example:

A mixture of 10 sccm nitrogen and 30 sccm H₂ (1:3) is led at a pressure of approx. 10 hPa through a quartz tube with an inside diameter of 13 mm, and a weak glow discharge (about 10 W) is produced on a section of approx. 12 cm within the tube by high voltage between two electrodes. Next, pulsed microwave radiation (2.45 GHz) with a pulse energy of 800 W and a pulse duration of 1 ms followed by 19 ms pause is injected on a 4.2-cm section, corresponding to an average power of 40 W. The resultant temperature of the reaction gas mixture, averaged over a period of at least 10 s, is up to 100° C. at reactor outlet. The product gas mixture is led through a trap cooled to 77 K, to freeze out the product that has formed (NH₃). After 6 h, the experiment is stopped and the cold trap is thawed. The evaporating NH₃ is led into distilled water and is titrated with aqueous HCl, to determine the yield. 29.5 mmol NH₃ is obtained, corresponding to a yield of approx. 10% of the value theoretically attainable.

1. A method for producing ammonia comprising reacting nitrogen (N₂) with hydrogen (H₂) with formation of a low-temperature plasma discharge.

2. The method according to claim 1, wherein the low-temperature plasma discharge is produced in a gas mixture consisting of N₂ and H₂ or comprising N₂ and H₂.

3. The method according to claim 1, wherein the low-temperature plasma discharge is produced in a gas subsequently mixed with a gas consisting of N₂ and/or H₂ or comprising N₂ and/or H₂.

4. The method according to claim 1, wherein the gas in which the low-temperature plasma discharge is produced further comprises a diluting inert gas. admixtures promoting the plasma discharge.

5. The method according to claim 1, wherein the low-temperature plasma discharge is generated by an alternating electromagnetic field.

6. The method according to claim 1, wherein the low-temperature plasma discharge is supported by penetration of free charge carriers into the discharge zone, and the free charge carriers are produced by applying a high voltage between electrodes.

7. The method according to claim 1, wherein ammonia production takes place at a pressure from 10 to 10000 Pa.

8. The method according to claim 1, wherein ammonia production takes place at a temperature of room temperature to 800° C.

9. The method according to claim 8, wherein wall temperature of a reactor in which ammonia production takes place is maintained between room temperature and 800° C.

10. The method according to claim 1, wherein the reaction of N₂ with H₂ takes place in the presence of a catalyst.
